(19) United States
(12) Patent Application Publication
(10) Pub. No.: US 2023/0241996 A1
(43) Pub. Date: Aug. 3, 2023

(54) SYSTEMS AND METHODS FOR CHARGING MULTIPLE ELECTRIC VEHICLES

(71) Applicant: Cummins Inc., Columbus, IN (US)

(72) Inventors: Mark N. Bays, Columbus, IN (US); Chetan Ponnathpur, Columbus, IN (US); Erik L. Piper, Columbus, IN (US); John P. O'Brien, Columbus, IN (US); Joseph E. Paquette, Columbus, IN (US); Dilip Ramachandran, Columbus, IN (US); Omkar A. Harshe, Columbus, IN (US); Ravikanth Pulipaka, Columbus, IN (US); John K. Heichelbech, Columbus, IN (US)

(21) Appl. No.: 18/104,022

(22) Filed: Jan. 31, 2023

Related U.S. Application Data
(60) Provisional application No. 63/304,750, filed on Jan. 31, 2022.

(51) Int. Cl. B60L 53/65; B60L 58/18; B60L 58/16; B60L 53/10

(52) U.S. Cl. CPC B60L 53/65; B60L 58/18; B60L 58/16; B60L 53/10

(57) ABSTRACT

The present disclosure provides systems and methods for charging multiple electric vehicles. In particular, the present disclosure provides a system having a single charger configured to connect with a plurality of electric vehicles and methods for charging one or more electric vehicles using said system. The present disclosure further provides a method for bidirectional current flow between the grid and the one or more electric vehicles.

### CROSS-REFERENCE TO RELATED APPLICATIONS

This application claims priority to U.S. Provisional Application No. 63/304,750, filed Jan. 31, 2022, which is hereby incorporated by reference in its entirety.

### FIELD OF THE DISCLOSURE

The present disclosure generally relates to electric vehicles, and more particularly to techniques for charging electric vehicles.

### BACKGROUND OF THE DISCLOSURE

Electric vehicles have a finite range and need to recharge their batteries by plugging in the electric vehicles at a charging station. The electric vehicles are recharged during periods of non-use in order to be ready for periods of use. However, a limited number of charging stations may cause scheduling difficulties for the efficient and timely recharging of the electric vehicles. Accordingly, there remains a need to develop techniques for charging multiple electric vehicles at the same time using a single charging station.

### SUMMARY

The present disclosure provides systems and methods for charging multiple electric vehicles. In particular, the present disclosure provides a system having a single charger configured to connect with a plurality of electric vehicles and methods for charging one or more electric vehicles using said system. The present disclosure further provides a method for bidirectional current flow between the grid and the one or more electric vehicles.

According to various embodiments, the present disclosure provides a system for charging multiple electric vehicles. The system includes a charging station connected to a plurality of electric vehicles and a controller coupled to the charging station. The controller is configured to determine a first set of charging parameters for a first electric vehicle in the plurality of electric vehicles including a first optimal charge level and a first total charge time, and determine a second set of charging parameters for a second electric vehicle in the plurality of electric vehicles including a second optimal charge level and a second total charge time. The controller is also configured to provide charging power to the first electric vehicle from the charging station for a first time period, where the first time period is less than the first total charge time. The controller is further configured to determine that the first electric vehicle has been charged to a first charge level for the first time period, where the first charge level is less than the first optimal charge level. The controller is also configured to provide charging power to the second electric vehicle from the charging station for a second time period, where the second time period is less than the second total charge time. The controller is further configured to determine that the second electric vehicle has been charged to a second charge level for the second time period, where the second charge level is less than the second optimal charge level.

According to various embodiments, the present disclosure provides a controller for charging multiple electric vehicles. The controller includes a processor and a memory. The memory includes instructions, that when executed by the processor, cause the controller to determine a first set of charging parameters for a first electric vehicle in a plurality of electric vehicles including a first optimal charge level and a first total charge time, and determine a second set of charging parameters for a second electric vehicle in the plurality of electric vehicles including a second optimal charge level and a second total charge time. The instructions, when executed by the processor, also cause the controller to provide charging power to the first electric vehicle from a charging station for a first time period, where the first time period is less than the first total charge time. The instructions, when executed by the processor, further cause the controller to determine that the first electric vehicle has been charged to a first charge level for the first time period, where the first charge level is less than the first optimal charge level. The instructions, when executed by the processor, also cause the controller to provide charging power to the second electric vehicle from the charging station for a second time period, where the second time period is less than the second total charge time. The instructions, when executed by the processor, further cause the controller to determine that the second electric vehicle has been charged to a second charge level for the second time period, where the second charge level is less than the second optimal charge level.

According to various embodiments, the present disclosure provides a method for charging multiple electric vehicles. The method determining a first set of charging parameters for a first electric vehicle in a plurality of electric vehicles including a first optimal charge level and a first total charge time, and determining a second set of charging parameters for a second electric vehicle in the plurality of electric vehicles including a second optimal charge level and a second total charge time. The method also includes providing charging power to the first electric vehicle from a charging station for a first time period, where the first time period is less than the first total charge time. The method further includes determining that the first electric vehicle has been charged to a first charge level for the first time period, where the first charge level is less than the first optimal charge level. The method also includes providing charging power to the second electric vehicle from the charging station for a second time period, where the second time period is less than the second total charge time. The method further includes determining that the second electric vehicle has been charged to a second charge level for the second time period, where the second charge level is less than the second optimal charge level.

According to various embodiments, the present disclosure provides a system. The system includes a charging station configured to connect to a plurality of electric vehicles and receive data from controls hardware of each vehicle of the plurality of vehicles and a controller coupled to the charging station so that the charging station is configured to transmit data to the controller. The controller is configured to receive a first set of data from the charging station to determine a first set of charging parameters for a first electric vehicle in the plurality of electric vehicles, including a first optimal charge level and a first total charge time. The controller is also configured to receive a second set of data from the charging station to determine a second set of charging parameters for a second electric vehicle in the plurality of electric vehicles, including a second optimal charge level and a second total charge time. The controller is also configured to transmit signals to command the charging station to provide charging power to the first electric vehicle for a first time period, the first time period being less than the first total charge time. The controller is also configured to receive a third set of data from the charging station to determine that the first electric vehicle has been charged to a first charge level for the first time period, the first charge level being less than the first optimal charge level. The controller is also configured to transmit signals to command the charging station to provide charging power to the second electric vehicle for a second time period, the second time period being less than the second total charge time and receive a fourth set of data from the charging station to determine that the second electric vehicle has been charged to a second charge level for the second time period, the second charge level being less than the second optimal charge level.

According to various embodiments, the present disclosure provides a method. The method includes receiving, to a controller, a first set of data; determining, by the controller using the first set of data, a first set of charging parameters for a first electric vehicle in a plurality of electric vehicles, the first set of charging parameters including a first optimal charge level and a first total charge time; receiving, to the controller, a second set of data; determining, by the controller using the second set of data, a second set of charging parameters for a second electric vehicle in the plurality of electric vehicles, the second set of charging parameters including a second optimal charge level and a second total charge time; commanding a charging station to provide power to the first electric vehicle by transmitting signals, with the controller, to the charging station; providing charging power to the first electric vehicle from the charging station for a first time period, the first time period being less than the first total charge time; receiving, to the controller, a third set of data; determining, by the controller using the third set of data, that the first electric vehicle has been charged to a first charge level for the first time period, the first charge level being less than the first optimal charge level; commanding the charging station to provide power to the second electric vehicle by transmitting signals, with the controller, to the charging station; providing charging power to the second electric vehicle from the charging station for a second time period, the second time period being less than the second total charge time; receiving, to the controller, a fourth set of data; and determining, by the controller using the fourth set of data, that the second electric vehicle has been charged to a second charge level for the second time period, the second charge level being less than the second optimal charge level.

In various embodiments, the first electric vehicle may be charged for a third time period where the third time period is less than the first total charge time, and the second electric vehicle may be charged for a fourth time period where the fourth time period is less than the second total charge time.

In various embodiments, the first electric vehicle may be charged to a third charge level for the third time period with the third charge level being greater than the first charge level but less than the first optimal charge level.

In various embodiments, the second electric vehicle may be charged to a fourth charge level for the fourth time period with the fourth charge level being greater than the second charge level but less than the second optimal charge level.

In various embodiments, the first electric vehicle may be charged for one or more time periods in addition to the first time period and the third time period, where a sum of the first time period, the third time period and the one or more time periods may be equal to the first total charge time.

In various embodiments, the first electric vehicle may be charged to the first optimal charge level after the one or more time periods.

In various embodiments, the second electric vehicle may be charged for one or more time periods in addition to the second time period and the fourth time period, where a sum of the second time period, the fourth time period and the one or more time periods may be equal to the second total charge time.

In various embodiments, the second electric vehicle may be charged to the second optimal charge level after the one or more time periods.

In various embodiments, charging the second electric vehicle for the second time period may be in response to determining that the first electric vehicle has been charged to the first charge level.

In various embodiments, charging the first electric vehicle for the third time period may be in response to determining that the second electric vehicle has been charged to the second charge level.

In certain embodiments, charging the second electric vehicle for the fourth time period may be in response to determining that the first electric vehicle has been charged to the third charge level.

In various embodiments, a first set of data including first telematics data and first battery aging data may be received from the first electric vehicle, and a second set of data including second telematics data and second battery aging data may be received from the second electric vehicle.

In various embodiments, a priority for providing charging power to the first electric vehicle or the second electric vehicle may be determined based on the first set of data and the second set of data.

In various embodiments, the first optimal charge level and the first total charge time may be determined based on the first telematics data and the first battery aging data.

In various embodiments, the second optimal charge level and the second total charge time may be determined based on the second telematics data and the second battery aging data.

In various embodiments, the controller may be further configured to selectively return power from at least one vehicle of the plurality of electric vehicles to a grid electrically coupled to the charging station.

In various embodiments, the controller may be further configured to transmit signals to command the charging station to provide charging power to the first electric vehicle form the charging station for a third time period, the third time period being less than the first total charge time; receive a fifth set of data from the charging station to determine that the first electric vehicle has been charged to a third charge level for the third time period, the third charge level being greater than the first charge level and less than the first optimal charge level; transmit signals to command the charging station to provide charging power to the second electric vehicle for a fourth time period, the fourth time period being less than the second total charge time; and receive a sixth set of data from the charging station to determine that the second electric vehicle has been charged to a fourth charge level for the fourth time period, the fourth charge level being greater than the second charge level and less than the second optimal charge level. The controller may be further configured to transmit signals to command the charging station to provide charging power to the first electric vehicle for one or more time periods in addition to the first time period and the third time period; and receive a seventh set of data from the charging station to determine that the first electric vehicle has been charged to the first optimal charge level after the one or more time periods; wherein a sum of the first time period, the third time period, and the one or more time periods may be equal to the first total charge time.

The controller may be further configured to transmit signals to command the charging station to provide charging power to the second electric vehicle from the charging station for one or more time periods in addition to the second time period and the fourth time period; and receive an eighth set of data to determine that the second electric vehicle has been charged to the second optimal charge level after the one or more time periods; wherein a sum of the second timer period, the fourth time period, and the one or more time periods may be equal to the second total charge time. The controller may be configured to transmit signals to command the charging station to provide charging power to the second electric vehicle for the second time period in response to determining that the first electric vehicle has been charged to the first charge level; transmit signals to command the charging station to provide charging power to the first electric vehicle for the third time period in response to determining that the second electric vehicle has been charged to the second charge level; and transmit signals to command the charging station to provide charging power to the second electric vehicle for the fourth time period in response to determining that the first electric vehicle has bene charged to the third charge level.

In various embodiments, the first set of data from the first electric vehicle may include first telematics data and first battery aging data associated with the first electric vehicle and the second set of data from the second electric vehicle may include second telematics data and second battery aging data associated with the second electric vehicle. The controller may be configured to determine a priority for providing charging power to the first electric vehicle or the second electric vehicle based on the first set of data and the second set of data. The controller may determine the first optimal charge level and the first total charge time based on the first telematics data and the first battery aging data; and the controller may determine the second optimal charge level and the second total charge time based on the second telematics data and the second battery aging data.

In various embodiments, the controller may be configured to transmit signals to the charging station to selectively return power from at least one vehicle of the plurality of electric vehicles to a grid electrically coupled to the charging station.

In various embodiments, the method may further comprise commanding the charging station to provide power to the first electric vehicle by transmitting signals, with the controller, to the charging station; providing charging power to the first electric vehicle from the charging station for a third time period, the third time period being less than the first total charge time; receiving, to the controller, a fifth set of data; determining, by the controller using the fifth set of data, that the first electric vehicle has been charged to a third charge level for the third time period, the third charge level being greater than the first charge level and less than the first optimal charge level; commanding the charging station to provide power to the second electric vehicle by transmitting signals, with the controller, to the charging station; providing charging power to the second electric vehicle from the charging station for a fourth time period, the fourth time period being less than the second total charge time; receiving to the controller, a sixth set of data; and determining, by the controller using the sixth set of data, that the second electric vehicle has been charged to a fourth charge level for the fourth time period, the fourth charge level being greater than the second charge level and less than the second optimal charge level. The method may further comprise commanding the charging station to provide power to the first electric vehicle by transmitting signals, with the controller, to the charging station; providing charging power to the first electric vehicle from the charging station for one or more time periods in addition to the first time period and the third time period; receiving, to the controller, a seventh set of data; and determining by the controller using the seventh set of data, that the first electric vehicle has been charged to the first optimal charge level after the one or more time periods; wherein a sum of the first time period, the third time period, and the one or more time periods may be equal to the first total charge time.

The method may further comprise commanding the charging station to provide power to the second electric vehicle by transmitting signals, with the controller, to the charging station; providing charging power to the second electric vehicle from the charging station for one or more time periods in addition to the second time period and the fourth time period; receiving, to the controller, an eighth set of data; and determining, by the controller using the eighth set of data, that the second electric vehicle has been charged to the second optimal charge level after the one or more time periods; wherein a sum of the second time period, the fourth time period, and the one or more time periods is equal to the second total charge time. Providing charging power to the second electric vehicle for the second time period may be in response to determining that the first electric vehicle has been charged to the first charge level. Providing charging power to the first electric vehicle for the third time period may be in response to determining that the second electric vehicle has been charged to the second charge level. Providing charging power to the second electric vehicle for the fourth time period may be in response to determining that the first electric vehicle has been charged to the third charge level.

In various embodiments, the first set of data may include first telematics data and first battery aging data associated with the first electric vehicle; the second set of data may include second telematics data and second battery aging data associated with the second electric vehicle; and the method may further comprise determining, by the controller, a priority for providing charging power to the first electric vehicle or the second electric vehicle based on the first set of data and the second set of data. The method may further comprise determining, by the controller, the first optimal charge level and the first total charge time based on the first telematics data and the first battery aging data; and determining, by the controller, the second optimal charge level and the second total charge time based on the second telematics data and the second battery aging data.

### BRIEF DESCRIPTION OF THE DRAWINGS

FIG. 1 is a block diagram illustrating a system for charging multiple electric vehicles;

FIG. 2 is a flow chart illustrating a method for charging multiple electric vehicles;

FIG. 3 is a flow chart illustrating a method for charging multiple electric vehicles;

FIG. 4 is a flow chart illustrating a method for returning power to a grid from multiple electric vehicles; and

FIG. 5 is a set of graphs illustrating state of charge versus time for charging multiple electric vehicles.

### DETAILED DESCRIPTION

For the purposes of promoting an understanding of the principles of the present disclosure, reference is now made to the embodiments illustrated in the drawings, which are described below. The embodiments disclosed herein are not intended to be exhaustive or to limit the disclosure to the precise form disclosed in the following detailed description. Rather, these embodiments were chosen and described so that others skilled in the art may utilize their teachings.

The terms “couples,” “coupled,” and variations thereof are used to include both arrangements wherein two or more components are in direct physical contact and arrangements wherein the two or more components are not in direct contact with each other (e.g., the components are “coupled” via at least a third component), but yet still cooperate or interact with each other.

Throughout the present disclosure and in the claims, numeric terminology, such as first and second, is used in reference to various components or features. Such use is not intended to denote an ordering of the components or features. Rather, numeric terminology is used to assist the reader in identifying the component or features being referenced and should not be narrowly interpreted as providing a specific order of components or features.

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower-level programming language.

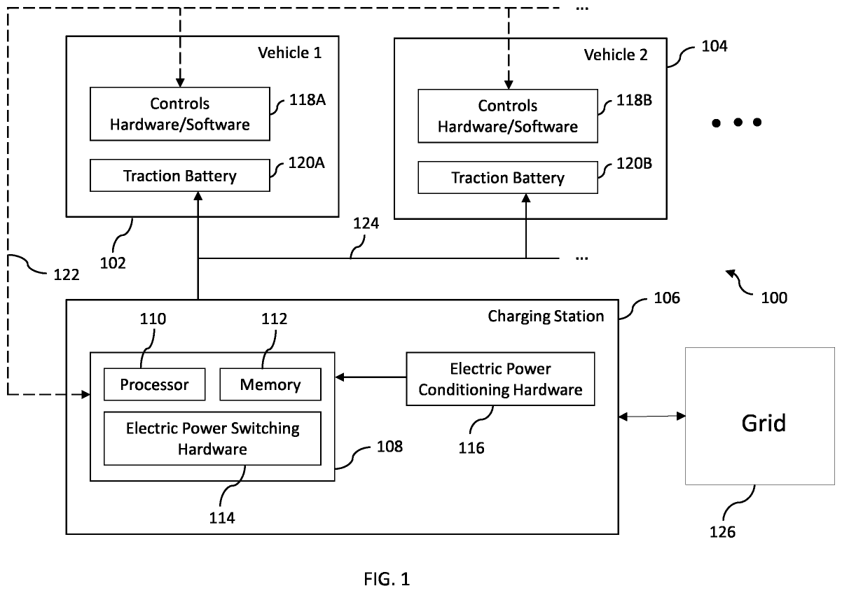

Referring to FIG. 1, a block diagram of a system 100 for charging multiple electric vehicles is shown including a plurality of electric vehicles, such as electric vehicles 102, 104, connected to a charging station 106. While only two electric vehicles are shown in FIG. 1, any suitable number of electric vehicles may be connected to charging station 106 at a given time. As used herein, the term “electric vehicle” refers to any vehicle that is partly or entirely operated based on stored electric power such as a pure electric vehicle, a hybrid electric vehicle, or the like. Such vehicles can include cars, trucks, buses, etc. In various embodiments, electric vehicles 102, 104 are part of a fleet of electric buses that charge/recharge at a bus depot where charging station 106 is located.

Charging station 106 is coupled to an electric grid 126 (e.g., a 3-phase distribution grid, a microgrid, etc.) to provide electric power to electric vehicles 102, 104. Charging station 106 may include a controller 108 having a memory 112 with stored instructions that, in response to execution by a processor 110, cause processor 110 to perform the functions of controller 108 as described herein. Memory 112, processor 110, and controller 108 are not particularly limited and can, for example, be physically separate. Controller 108 may also include electric power switching hardware 114 to switch between the charging of different electric vehicles. For example, electric power switching hardware 114 may include one or more switches, relays, and other switching devices to control the sequential and/or simultaneous (parallel) charging of electric vehicles 102, 104. In some examples, controller 108 may be an external device coupled to charging station 106.

In certain embodiments, controller 108 may form a portion of a processing subsystem including one or more computing devices having memory, processing, and communication hardware. For example, controller 108 may be a single device or a distributed device, and the functions of controller 108 may be performed by hardware and/or as computer instructions on a non-transient computer readable storage medium (e.g., memory 112). In some embodiments, controller 108 may include one or more interpreters, determiners, evaluators, regulators, and/or processors that functionally execute the operations of controller 108. Interpreters, determiners, evaluators, regulators, and processors can be implemented in hardware and/or as computer instructions on a non-transient computer readable storage medium and can be distributed across various hardware or computer-based components.

To facilitate high power charging, charging station 106 may include electric power conditioning hardware 116 that convert alternating current (AC) power (e.g., grid power) to direct current (DC) power for supply to electric vehicles 102, 104. For example, electric power conditioning hardware 116 may include various components for performing tasks such as AC-to-DC conversion, voltage regulation, DC-to-DC conversion, etc. In various examples, such as those discussed further herein, electric power conditioning hardware 116 may further be configured to convert direct current (DC) power to alternating current (AC) power for selectively returning power supply to the grid. In various examples, electric power conditioning hardware 116 may determine a charging rate for charging station 106.

Each of electric vehicles 102, 104 may include, among other things, respective controls hardware/software 118A, 118B, and respective traction batteries 120A, 120B. For ease of illustration, other components of electric vehicles 102, 104 (e.g., transmissions, brakes, wheels, etc.) are not shown, the operations of which are known to those skilled in the art.

Controls hardware/software 118A, 118B may include any number of electronic control units and/or software modules (e.g., vehicle monitoring unit, battery management system (BMS), etc.) that oversee the operation of electric vehicles 102, 104. For example, controls hardware/software 118A, 118B may determine the status of traction batteries 120A, 120B and the need to charge/recharge them. Controls hardware/software 118A, 118B may communicate with charging station 106 by sending data regarding electric vehicles 102, 104 to controller 108 via signal links 122, which may be wired and/or wireless connections. In turn, controller 108 may receive and processe the data to generate various charging parameters (e.g., charge levels, charge times, etc.) for charging electric vehicles 102, 104. Traction batteries 120A, 120B may be physically connected to charging station 106 using connectors 124 (e.g., socket outlet, plug, cable, etc.). Once controller 108 determines the necessary charging parameters, charging power may be provided to electric vehicles 102, 104 via connectors 124. In some embodiments, traction batteries 120A, 120B may be wirelessly connected to charging station 106.

In various embodiments, delayed charging may be implemented by controller 108 to keep the state of charge (SOC) of traction batteries 120A, 120B at low levels for a higher percentage of time until electric vehicles 102, 104 are ready for use. In this manner, optimization in battery life and charging operations may be achieved for multiple electric vehicles connected to a single charging station. In some examples, controller 108 may determine an appropriate number of electric vehicles that may be connected to charging station 106 before optimization efforts are no longer effective. This information may be used to ensure that there is an acceptable number of charging stations for the intended vehicle count.

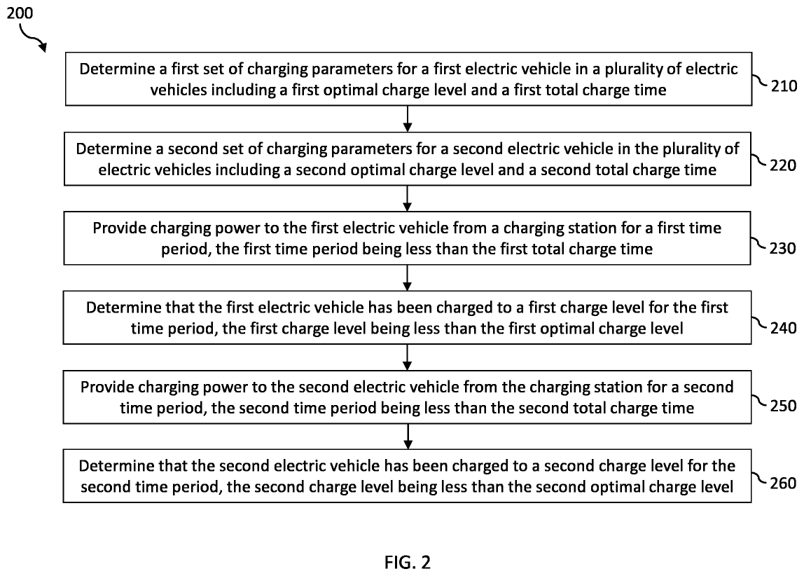

Referring now to FIG. 2, a method 200 for charging multiple electric vehicles (e.g., vehicles 102, 104) is shown. For example, method 200 may be performed by a controller (e.g., 108). Method 200 implements a process that delays the charging of batteries (e.g., 120A, 120B) in electric vehicles to ensure that optimized levels of charge are available in the electric vehicles just before their start of use. This is done so that the batteries are at the lowest state of charge when not in use which may help extend the life of the batteries. In this regard, each of the electric vehicles may be cycled at lower life conditions. In various embodiments, method 200 may be used to charge a fleet of electric buses. For example, the electric buses may be plugged into a charging station, but charging of the electric buses is not completed until just before the start of each bus route.

At block 210, the controller (e.g. 108) determines a first set of charging parameters for a first electric vehicle (e.g., 102) in a plurality of electric vehicles connected to a charging station (e.g., 106). The first set of charging parameters may include a first optimal charge level and a first total charge time for the first electric vehicle 102. For example, the first optimal charge level may indicate an optimal SOC level for a battery 120A in the first electric vehicle 102. As an example, the first total charge time may indicate the time required to charge the battery 120A in the first electric vehicle 102 from a current SOC level to the optimal SOC level.

In certain embodiments, the controller 108 may receive a first set of data from the first electric vehicle 102 including first telematics data (e.g., speed, location, times of operation, mileage driven, etc.) and first battery aging data (e.g., battery cell aging curves, battery state of health (SOH), etc.) associated with the first electric vehicle 102. In some embodiments, the controller 108 may determine the first optimal charge level and the first total charge time based on the first telematics data and the first battery aging data. For example, the first telematics data may be used to determine a route profile for the first electric vehicle 102 (e.g., route starting time, route ending time, length of route, etc.). As an example, the first battery aging data may be used to determine levels of SOC that optimize battery life (e.g., SOC level during operation vs. non-operation). By using the first telematics data and the first battery aging data, the controller 108 can estimate usage of the first electric vehicle 102 during the next route run and determine the first optimal charge level and the first total charge time needed for the next route run to take place.

At block 220, the controller 108 determines a second set of charging parameters for a second electric vehicle (e.g., 104) in the plurality of electric vehicles. The second set of charging parameters may include a second optimal charge level and a second total charge time for the second electric vehicle 104. For example, the second optimal charge level may indicate an optimal SOC level for a battery in the second electric vehicle 104. As an example, the second total charge time may indicate the time required to charge the battery 120B in the second electric vehicle 104 from a current SOC level to the optimal SOC level. In some embodiments, the controller 108 may receive a second set of data from the second electric vehicle 104 including second telematics data and second battery aging data associated with the second electric vehicle 104. In certain embodiments, the controller 108 may determine the second optimal charge level and the second total charge time based on the second telematics data and the second battery aging data.

In other embodiments, additional information (e.g., plug in times, previous charge levels, previous charge times, ambient conditions at the charging station, etc.) may be aggregated and analyzed to determine the first/second optimal charge levels and/or the first/second total charge times. In some examples, a safety margin may be added to the first/second optimal charge levels so that the first and second electric vehicles 102, 104 will always have enough power return to the charging station 106 after each route run. In other examples, the first/second optimal charge levels and/or the first/second total charge times may be displayed on a device (e.g., an interface on the charging station, a workstation, a tablet, etc.) to allow an operator to confirm, override, and/or modify.

In various embodiments, the controller 108 may determine a priority for providing charging power to the first electric vehicle 102 or the second electric vehicle 104 based on the first set of data and the second set of data. For example, the controller 108 may determine that the first electric vehicle 102 is scheduled to leave the charging station 106 at an earlier time than the second electric vehicle 104 (e.g., starting an earlier route). As an example, the controller 108 may enable sequential charging where the first electric vehicle 102 begins charging before the second electric vehicle 104. For example, the controller 108 may determine that both the first electric vehicle 102 and the second electric vehicle 104 can leave the charging station 106 together. As an example, the controller 108 may enable simultaneous charging where the first electric vehicle 102 and the second electric vehicle 104 are charged at the same time.

At block 230, the controller 108 commands, by transmitting signals to, the charging station 106 to provide charging power to the first electric vehicle 102 from the charging station 106 for a first time period, where the first time period may be less than the first total charge time. At block 240, the controller 108 determines that the first electric vehicle 102 has been charged to a first charge level during the first time period by receiving data relative to such determination via the charging station 106. The first charge level may be less than the first optimal charge level.

At block 250, the controller 108 commands, by transmitting signals to, the charging station 106 to provide charging power to the second electric vehicle 104 from the charging station 106 for a second time period, where the second time period may be less than the second total charge time. In some embodiments, charging power may be provided for the second time period in response to the controller 108 determining that the first electric vehicle 102 has been charged to the first charge level. At block 260, the controller 108 determines that the second electric vehicle 104 has been charged to a second charge level during the second time period by receiving data relative to such determination via the charging station 106. The second charge level may be less than the second optimal charge level.

In certain embodiments, the controller 108 may command the charging station 106 to provide charging power to the first electric vehicle 102 from the charging station 106 for a third time period, where the third time period may be less than the first total charge time. In some embodiments, charging power may be provided for the third time period in response to the controller 108 determining that the second electric vehicle 104 has been charged to the second charge level. In certain embodiments, the controller 108 may determine that the first electric vehicle 102 has been charged to a third charge level during the third time period by receiving data relative to such determination via the charging station 106. The third charge level may be greater than the first charge level but less than the first optimal charge level.

In some embodiments, the controller 108 may command the charging station 106 to provide charging power to the second electric vehicle 104 from the charging station 106 for a fourth time period, where the fourth time period may be less than the second total charge time. In certain embodiments, charging power may be provided for the fourth time period in response to the controller 108 determining that the first electric vehicle 102 has been charged to the third charge level. In some embodiments, the controller 108 may determine that the second electric vehicle 104 has been charged to a fourth charge level for the fourth time period by receiving data relative to such determination via the charging station 106. The fourth charge level may be greater than the second charge level but less than the second optimal charge level.

In various embodiments, the controller 108 may command the charging station 106 to provide charging power to the first and second electric vehicles 102, 104 for additional time periods until the respective optimal charge levels are reached. For example, the controller 108 may command the charging station 106 to provide charging power to the first electric vehicle 102 for one or more time periods besides the first time period and the third time period, where a sum of the first time period, the third time period, and the one or more time periods may be equal to the first total charge time. As an example, the controller 108 may determine that the first electric vehicle 102 has been charged to the first optimal charge level after the one or more time periods besides the first time period and the third time period by receiving data relative to such determinations via the charging station 106. For example, the controller 108 may command the charging station 106 to provide charging power to the second electric vehicle 104 for one or more time periods besides the second time period and the fourth time period, where a sum of the second time period, the fourth time period, and the one or more time periods is equal to the second total charge time. As an example, the controller 108 may determine that the second electric vehicle 104 has been charged to the second optimal charge level after the one or more time periods besides the second time period and the fourth time period by receiving data relative to such determinations via the charging station 106.

By using method 200, charge levels and charge times may be delayed or staggered in order to keep the battery SOC levels as low as possible for as long as possible until the electric vehicles 102, 104 are ready for use. Method 200 is generalizable to any suitable number of electric vehicles connected to the charging station 106.

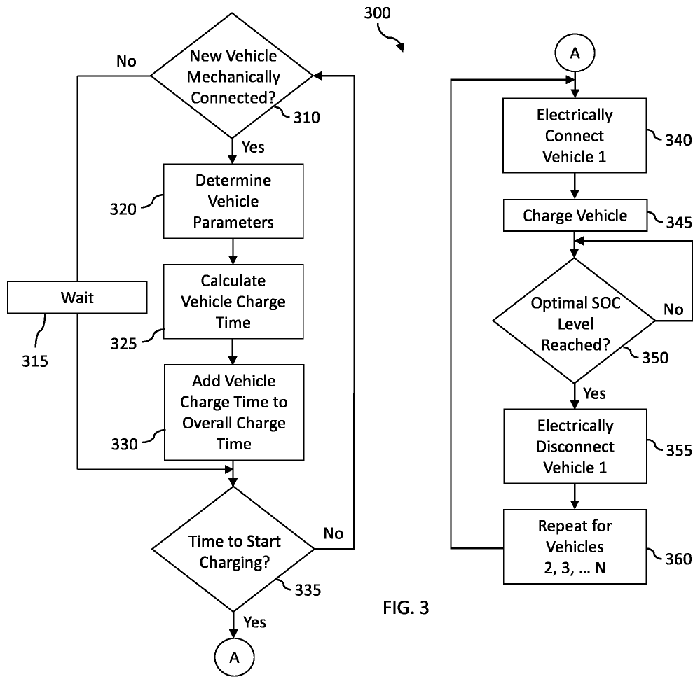

Referring next to FIG. 3, a method 300 for charging multiple electric vehicles (e.g. 102, 104) is shown. For example, method 300 may be performed by a controller (e.g., 108). Method 300 implements a process that charges a plurality of electric vehicles (e.g., vehicle 1 to N) connected to a single charging station (e.g. 106) in a sequential manner.

At block 310, the controller 108 determines if a new or additional electric vehicle (e.g., 102, 104) has been mechanically connected to the charging station. If no new vehicle has been connected, the controller waits at block 315 before proceeding further. If a new vehicle has been connected, at block 320, the controller 108 determines vehicle parameters associated with the new electric vehicle. For example, the controller 108 may determine one or more parameters related to a battery (e.g., 120A, 120B) of the new electric vehicle (e.g., current SOC level, current SOH level, optimal SOC level, etc.). As an example, the controller 108 may determine one or more parameters related to a route profile of the new electric vehicle (e.g., route starting time, route ending time, etc.). The route profile may be determined based on telematics data from the new electric vehicle. At block 325, the controller 108 calculates a vehicle charge time indicating the time needed to charge the battery of the new electric vehicle to the optimal SOC level. At block 330, the controller 108 adds the vehicle charge time to an overall charge time for charging all electric vehicles connected to the charging station. At block 335, the controller 108 determines if it is time to start charging all the electric vehicles connected to the charging station 106. If so, the controller 108 proceeds to sequentially charge the electric vehicles.

At block 340, the controller 108 electrically connects with a first electric vehicle (e.g., vehicle 1). For example, the controller 108 may activate a switch that allows charging power to be delivered to vehicle 1 from the charging station 106. At block 345, vehicle 1 may be charged. At block 350, the controller 108 determines if the optimal SOC level in vehicle 1 has been reached. If so, at block 355, the controller 108 electrically disconnects vehicle 1. At block 360, the controller 108 repeats the process in blocks 340-355 for all other electric vehicles (e.g., vehicles 2 to N) connected to the charging station 106. If one of the multiple electric vehicles is disconnected before reaching the optimal SOC level, (e.g., if a user disconnects a vehicle before said vehicle has reached the optimal SOC level or if charging of a vehicle otherwise ends before reaching the optimal SOC level), method 300 may continue with the remaining vehicles and the disconnected vehicle is removed from the method.

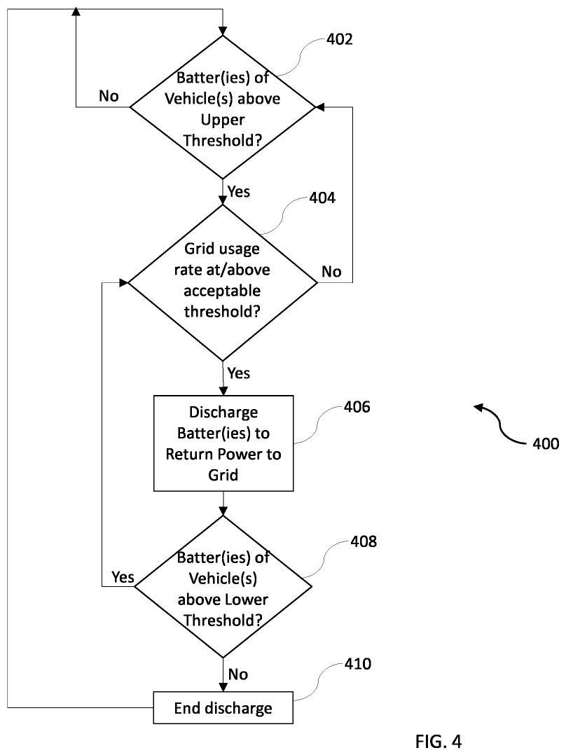

Referring briefly to FIG. 1, in some embodiments, the controller 108 may be configured to selectively return power from at least one of the connected vehicles 102, 104 to the grid 126. Referring to FIG. 4, a method 400 for returning power to the grid is illustrated. At block 402, the controller 108 determines whether the state-of-charge of corresponding battery or batteries 120A, 120B of the connected vehicle(s) 102, 104 is above an upper threshold.

For example, memory 112 may have stored an upper state-of-charge threshold and a lower state-of-charge threshold for each vehicle 102, 104. The upper state-of-charge threshold is a selected threshold at which the vehicle may return power to grid 126 if desired. The lower state-of-charge threshold may be a selected threshold at which the vehicle 102, 104 is capable of completing its assigned route and returning to charger 106. In some embodiments, each of the vehicles 102, 104 may have the same or similar upper and lower state-of-charge thresholds. In other embodiments, each of the vehicles 102, 104 may have differing, more personalized upper and lower state-of-charge thresholds. In other embodiments, some vehicles may have similar or the same thresholds as other vehicles while other vehicles have differing upper and lower state-of-charge thresholds. Each of the upper state-of-charge threshold and the lower state-of-charge threshold may be selected by a user.

During some events, e.g., in the event of a civil emergency, the grid usage rate may be extremely high. In other words, it is foreseeable that certain events may necessitate or facilitate a high grid demand resulting in a high demand for battery power, such as a grid failure, natural disaster, or other catastrophic event that increases the need for supplemental power to continue the operation of hospitals, community centers (e.g., at a school), and other civic or community operations. During such event, it may be desirable to lower the lower state-of-charge threshold below a level at which the vehicle would be able to complete any route or other mission. In other words, a user may select a lower state-of-charge threshold that, if met, would not allow the corresponding vehicle to complete a subsequent route or mission.

If, at block 402, the state-of-charge of the corresponding battery or batteries 120A, 120B of the vehicle(s) 102, 104 is above the upper threshold, method 400 moves to block 404. If the state-of-charge of the corresponding battery or batteries 120A, 120B of the vehicle(s) 102, 104 is not above the upper threshold, method 400 returns to block 402. In other words, the controller 108 may monitor the state-of-charge of the battery or batteries 120A, 120B of the vehicle(s) 102, 104 in a continuous or semi-continuous manner.

At block 404, controller 108 determines whether the grid usage rate is at or above an acceptable threshold. If, for example, the current cost of grid usage is greater than the cost at which energy was purchased to charge the vehicle(s) 102, 104, then controller 108 may determine that the grid usage rate is at an acceptable threshold. Other acceptable threshold levels may be selected. For example, rather than controller 108 running a comparison of usage rates, a user may select a specific usage rate as the acceptable grid usage rate. If the grid usage rate is not at or above an acceptable threshold, then method 400 returns to block 402. If the grid usage rate is at or above an acceptable threshold, method 400 moves to block 406.

At block 406, the battery or batteries 120A, 120B of the connected vehicle(s) 102, 104 are discharged to return power to grid 126. The discharge method or sequence may be similar, but inverted, to either of methods 200 or 300. In other words, in some embodiments, the discharge charge levels and discharge times are delayed or staggered in order to keep the battery SOC levels as high as possible for as long as possible until the electric vehicles are ready for use, similar to charging method 200. In other embodiments, a process that discharges a plurality of electric vehicles (e.g., vehicle 1 to N) connected to a single charging station in a sequential manner may be used. At block 406, the battery or batteries 120A, 120B are discharged in a manner similar but inverted as to that described above in either of methods 200, 300, where electric power switching hardware 114 is configured to convert DC power to AC power to return power to grid 126.

At block 408, controller 108 determines whether the state-of-charge of the battery or batteries 120A, 120B of the vehicle(s) is above the lower threshold. As discussed above, the lower threshold may be selected so that, if the lower threshold is met, the corresponding vehicle is capable of completing a subsequent route and returning to charger 106. In other embodiments, e.g., during events in which grid usage demand is exceedingly high due to an emergency, the lower threshold may be selected to correspond with a state-of-charge that would not allow the corresponding vehicle to complete a subsequent route. If the state-of-charge of the battery or batteries 120A, 120B is above the lower threshold, method 400 returns to block 404. If the grid usage rate remains at or above the selected acceptable threshold, the method continues to discharge the battery or batteries 120A, 120B. If, at block 408, the lower threshold is met, discharge of the battery or batteries 120A, 120B ends at block 410. Method 400 then returns to block 402, where controller 108 continues method 400 until the vehicle(s) are disconnected from charger 106. In other words, as long as the state-of-charge of the battery or batteries of the connected vehicle(s) remains above the lower threshold and the grid usage rate remains at or above an acceptable threshold, controller 108 will direct power back to grid 126.

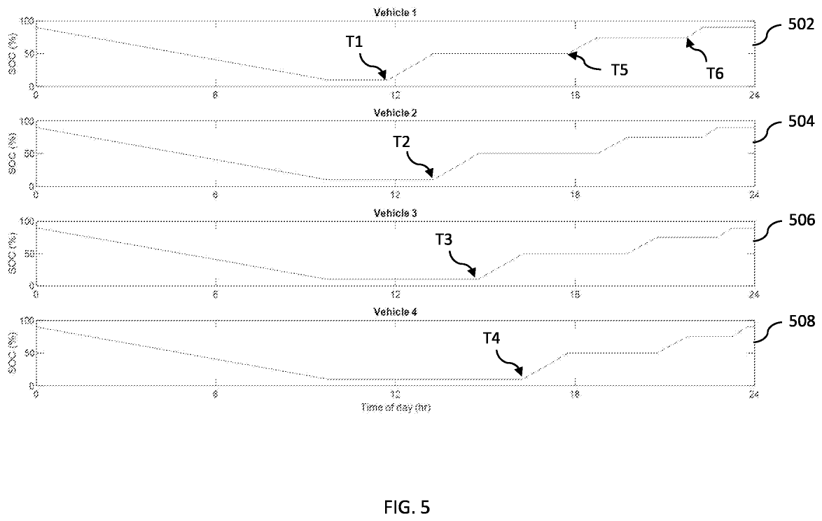

In FIG. 5, graphs 502-508 show delayed charging for at least four electric vehicles. The x-axes represent time while the y-axes represent SOC level. As can be seen, vehicle 1 starts charging at time T1, followed by vehicle 2 at T2, vehicle 3 at T3, and finally vehicle 4 at T4. After reaching certain SOC levels, vehicle 1 waits for periods of time before charging again at T5 and T6. This pattern of delayed charging is repeated for vehicles 2-4. The result is a stepped charging profile for each of vehicles 1-4.

This application is intended to cover any variations, uses, or adaptations of the present disclosure using its general principles. Further, this application is intended to cover such departures from the present disclosure as come within known or customary practice in the art to which the present disclosure pertains and which fall within the limits of the appended claims.

Furthermore, the connecting lines shown in the various figures contained herein are intended to represent functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.”

Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic with the benefit of this disclosure in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system, comprising:
a charging station configured to connect to a plurality of electric vehicles and receive data from controls hardware of each vehicle of the plurality of vehicles; and
a controller coupled to the charging station so that the charging station is configured to transmit data to the controller, the controller configured to:
receive a first set of data from the charging station to determine a first set of charging parameters for a first electric vehicle in the plurality of electric vehicles including a first optimal charge level and a first total charge time;
receive a second set of data from the charging station to determine a second set of charging parameters for a second electric vehicle in the plurality of electric vehicles including a second optimal charge level and a second total charge time;
transmit signals to command the charging station to provide charging power to the first electric vehicle for a first time period, the first time period being less than the first total charge time;
receive a third set of data from the charging station to determine that the first electric vehicle has been charged to a first charge level for the first time period, the first charge level being less than the first optimal charge level;
transmit signals to command the charging station to provide charging power to the second electric vehicle for a second time period, the second time period being less than the second total charge time; and
receive a fourth set of data from the charging station to determine that the second electric vehicle has been charged to a second charge level for the second time period, the second charge level being less than the second optimal charge level.

2. The system of claim 1, wherein the controller is further configured to:
transmit signals to command the charging station to provide charging power to the first electric vehicle from the charging station for a third time period, the third time period being less than the first total charge time;
receive a fifth set of data from the charging station to determine that the first electric vehicle has been charged to a third charge level for the third time period, the third charge level being greater than the first charge level and less than the first optimal charge level;
transmit signals to command the charging station to provide charging power to the second electric vehicle for a fourth time period, the fourth time period being less than the second total charge time; and
receive a sixth set of data from the charging station to determine that the second electric vehicle has been charged to a fourth charge level for the fourth time period, the fourth charge level being greater than the second charge level and less than the second optimal charge level.

3. The system of claim 2, wherein the controller is further configured to:
transmit signals to command the charging station to provide charging power to the first electric vehicle for one or more time periods in addition to the first time period and the third time period; and
receive a seventh set of data from the charging station to determine that the first electric vehicle has been charged to the first optimal charge level after the one or more time periods;
wherein a sum of the first time period, the third time period, and the one or more time periods is equal to the first total charge time.

4. The system of claim 2, wherein the controller is further configured to:
transmit signals to command the charging station to provide charging power to the second electric vehicle from the charging station for one or more time periods in addition to the second time period and the fourth time period; and
receive an eighth set of data to determine that the second electric vehicle has been charged to the second optimal charge level after the one or more time periods;
wherein a sum of the second time period, the fourth time period, and the one or more time periods is equal to the second total charge time.

5. The system of claim 2, wherein the controller is configured to:
transmit signals to command the charging station to provide charging power to the second electric vehicle for the second time period in response to determining that the first electric vehicle has been charged to the first charge level;
transmit signals to command the charging station to provide charging power to the first electric vehicle for the third time period in response to determining that the second electric vehicle has been charged to the second charge level; and
transmit signals to command the charging station to provide charging power to the second electric vehicle for the fourth time period in response to determining that the first electric vehicle has been charged to the third charge level.

6. The system of claim 1, wherein:
the first set of data from the first electric vehicle includes first telematics data and first battery aging data associated with the first electric vehicle;
the second set of data from the second electric vehicle includes second telematics data and second battery aging data associated with the second electric vehicle; and
the controller is further configured to determine a priority for providing charging power to the first electric vehicle or the second electric vehicle based on the first set of data and the second set of data.

7. The system of claim 6, wherein the controller determines the first optimal charge level and the first total charge time based on the first telematics data and the first battery aging data; and
the controller determines the second optimal charge level and the second total charge time based on the second telematics data and the second battery aging data.

8. The system of claim 1, wherein the controller is further configured to transmit signals to the charging station to selectively return power from at least one vehicle of the plurality of electric vehicles to a grid electrically coupled to the charging station.

9. A controller, comprising:
a processor; and
a memory including instructions that, when executed by the processor, cause the controller to:
determine a first set of charging parameters for a first electric vehicle in a plurality of electric vehicles including a first optimal charge level and a first total charge time;
determine a second set of charging parameters for a second electric vehicle in the plurality of electric vehicles including a second optimal charge level and a second total charge time;
provide charging power to the first electric vehicle from a charging station for a first time period, the first time period being less than the first total charge time;
determine that the first electric vehicle has been charged to a first charge level for the first time period, the first charge level being less than the first optimal charge level;
provide charging power to the second electric vehicle from the charging station for a second time period, the second time period being less than the second total charge time; and
determine that the second electric vehicle has been charged to a second charge level for the second time period, the second charge level being less than the second optimal charge level.

10. The controller of claim 9, wherein the instructions, when executed by the processor, further cause the controller to:
provide charging power to the first electric vehicle from the charging station for a third time period, the third time period being less than the first total charge time;
determine that the first electric vehicle has been charged to a third charge level for the third time period, the third charge level being greater than the first charge level and less than the first optimal charge level;
provide charging power to the second electric vehicle from the charging station for a fourth time period, the fourth time period being less than the second total charge time; and
determine that the second electric vehicle has been charged to a fourth charge level for the fourth time period, the fourth charge level being greater than the second charge level and less than the second optimal charge level.

11. The controller of claim 10, wherein the instructions, when executed by the processor, further cause the controller to:
provide charging power to the first electric vehicle from the charging station for one or more time periods in addition to the first time period and the third time period; and
determine that the first electric vehicle has been charged to the first optimal charge level after the one or more time periods;
wherein a sum of the first time period, the third time period, and the one or more time periods is equal to the first total charge time.

12. The controller of claim 10, wherein the instructions, when executed by the processor, further cause the controller to:
provide charging power to the second electric vehicle from the charging station for one or more time periods in addition to the second time period and the fourth time period; and
determine that the second electric vehicle has been charged to the second optimal charge level after the one or more time periods;
wherein a sum of the second time period, the fourth time period, and the one or more time periods is equal to the second total charge time.

13. The controller of claim 9, wherein the instructions, when executed by the processor, further cause the controller to:
receive a first set of data from the first electric vehicle including first telematics data and first battery aging data associated with the first electric vehicle;
receive a second set of data from the second electric vehicle including second telematics data and second battery aging data associated with the second electric vehicle; and
determine a priority for providing charging power to the first electric vehicle or the second electric vehicle based on the first set of data and the second set of data.

14. The controller of claim 13, wherein the instructions, when executed by the processor, further cause the controller to:
determine the first optimal charge level and the first total charge time based on the first telematics data and the first battery aging data; and
determine the second optimal charge level and the second total charge time based on the second telematics data and the second battery aging data.

15. A method, comprising:
receiving, to a controller, a first set of data;
determining, by the controller using the first set of data, a first set of charging parameters for a first electric vehicle in a plurality of electric vehicles, the first set of charging parameters including a first optimal charge level and a first total charge time;
receiving, to the controller, a second set of data;
determining, by the controller using the second set of data, a second set of charging parameters for a second electric vehicle in the plurality of electric vehicles, the second set of charging parameters including a second optimal charge level and a second total charge time;
commanding a charging station to provide power to the first electric vehicle by transmitting signals, with the controller, to the charging station;
providing charging power to the first electric vehicle from the charging station for a first time period, the first time period being less than the first total charge time;
receiving, to the controller, a third set of data;
determining, by the controller using the third set of data, that the first electric vehicle has been charged to a first charge level for the first time period, the first charge level being less than the first optimal charge level;
commanding the charging station to provide power to the second electric vehicle by transmitting signals, with the controller, to the charging station;
providing charging power to the second electric vehicle from the charging station for a second time period, the second time period being less than the second total charge time;
receiving, to the controller, a fourth set of data; and
determining, by the controller using the fourth set of data, that the second electric vehicle has been charged to a second charge level for the second time period, the second charge level being less than the second optimal charge level.

16. The method of claim 15, further comprising:
commanding the charging station to provide power to the first electric vehicle by transmitting signals, with the controller, to the charging station;
providing charging power to the first electric vehicle from the charging station for a third time period, the third time period being less than the first total charge time;
receiving, to the controller, a fifth set of data; and
determining, by the controller using the fifth set of data, that the first electric vehicle has been charged to a third charge level for the third time period, the third charge level being greater than the first charge level and less than the first optimal charge level;
commanding the charging station to provide power to the second electric vehicle by transmitting signals, with the controller, to the charging station;
providing charging power to the second electric vehicle from the charging station for a fourth time period, the fourth time period being less than the second total charge time;
receiving, to the controller, a sixth set of data;
determining, by the controller using the sixth set of data, that the second electric vehicle has been charged to a fourth charge level for the fourth time period, the fourth charge level being greater than the second charge level and less than the second optimal charge level.

17. The method of claim 16, further comprising:
commanding the charging station to provide power to the first electric vehicle by transmitting signals, with the controller, to the charging station;
providing charging power to the first electric vehicle from the charging station for one or more time periods in addition to the first time period and the third time period;
receiving, to the controller, a seventh set of data; and
determining, by the controller using the seventh set of data, that the first electric vehicle has been charged to the first optimal charge level after the one or more time periods;
wherein a sum of the first time period, the third time period, and the one or more time periods is equal to the first total charge time.

18. The method of claim 16, further comprising:
commanding the charging station to provide power to the second electric vehicle by transmitting signals, with the controller, to the charging station;
providing charging power to the second electric vehicle from the charging station for one or more time periods in addition to the second time period and the fourth time period;
receiving, to the controller, an eighth set of data; and
determining, by the controller using the eighth set of data, that the second electric vehicle has been charged to the second optimal charge level after the one or more time periods;
wherein a sum of the second time period, the fourth time period, and the one or more time periods is equal to the second total charge time.

19. The method of claim 16, wherein:
providing charging power to the second electric vehicle for the second time period is in response to determining that the first electric vehicle has been charged to the first charge level;
providing charging power to the first electric vehicle for the third time period is in response to determining that the second electric vehicle has been charged to the second charge level; and
providing charging power to the second electric vehicle for the fourth time period is in response to determining that the first electric vehicle has been charged to the third charge level.

20. The method of claim 15, wherein:
the first set of data includes first telematics data and first battery aging data associated with the first electric vehicle;
the second set of data includes second telematics data and second battery aging data associated with the second electric vehicle; and
the method further comprises determining, by the controller, a priority for providing charging power to the first electric vehicle or the second electric vehicle based on the first set of data and the second set of data.
